(19) United States
(12) Patent Application Publication
(10) Pub. No.: US 2011/0254769 A1
(43) Pub. Date: Oct. 20, 2011

(54) MOUSE HAVING SIX MOVEMENT AXES

(75) Inventor: Eric Delattre, Villeneuve D'ascq (FR)

(73) Assignee: LEXIP, VILLENEUVE-D'ASCQ (FR)

(21) Appl. No.: 13/125,127

(22) PCT Filed: Oct. 19, 2009
(86) PCT No.: PCT/FR2009/001219

§ 371 Date: Jul. 11, 2011

(30) Foreign Application Priority Data
Oct. 20, 2008 (FR) 08/05785

(51) Int. Cl. G09G 5/08

(52) U.S. Cl. 345/163

(57) ABSTRACT

The invention relates to a mouse having six axes for controlling a three-dimensional application. The mouse (1) with six movement axes (x, y) comprises a soleplate (2) and a housing (3) connected to each other by a connection element (6) allowing the housing to move in rotation relative to the soleplate about two axes (x, y). The housing (3) is provided with a sensor (16) situated in register with the thumb of a user's hand that is holding the housing (3), to cause switching of the mouse (1) from a two-dimensional mode of use to a three-dimensional mode of use of the mouse (1) on detecting pressure exerted by the thumb on the sensor (16). The invention is applicable to three-dimensional computer applications.

The invention relates to a mouse having six movement axes for use in controlling a three-dimensional software application, and more generally a six-axis pointer enabling such an application to be controlled.

### BACKGROUND OF THE INVENTION

The invention relates to using a peripheral such as the six-axis mouse described in patent documents FR 2 858 072 and FR 2 881 238. That mouse comprises a housing that is movable in translation in a plane along two perpendicular horizontal axes, and in rotation about a third axis normal to the plane, like a standard so-called “two-dimensional” mouse. However that housing is also movable in rotation about each of the horizontal axes and it is also provided with a scroll wheel that constitutes its sixth movement axis.

That mouse is for use in manipulating virtual digital three-dimensional articles presented by a software application, such as a computer-assisted design application.

It can thus be used for controlling the application in such a manner as to couple the movements of a three-dimensional article presented by the application on the computer screen with the actual movements of the mouse housing. The movements that the user imparts to the housing of the mouse and the actuation of the scroll wheel are translated into corresponding movements of the article being manipulated.

The mouse may also be used for moving in a digital three-dimensional space. The actual movements of the housing are then translated into movements and into changes in the orientation of the viewpoint from which said three-dimensional space is presented by the application.

Either way, movement translation may be isotonic or elastic. In isotonic operation, a movement of the housing is translated by a corresponding movement of the article or of the viewpoint, in application of some level of gain that is fixed or that depends on the actual speed of the movement of the housing. In elastic operation, a movement of the housing is translated by a speed of movement of the article or of the viewpoint: the article turns faster when the housing is tilted to a greater extent.

In order to select an element of the article or of the scene presented by the application, the user uses the three-dimensional mouse to position the article or the point from which the scene is viewed so as to make the element in question visible on the screen.

The user then takes hold of another mouse, a two-dimensional mouse, to move a cursor associated with said two-dimensional mouse onto the element that is to be selected, and for example the user then clicks with the two-dimensional mouse in order to select said element, thereby subsequently enabling the user to modify one or more parameters associated with said example, such as its color, its dimensions, etc.

In analogous manner, the user takes hold of the three-dimensional mouse to switch from a three-dimensional application to an office application such as a word processor application.

In practice, when the user lets go of the housing of the three-dimensional mouse, the housing is returned by the resilient return means fitted thereto towards a neutral position in which it is not tilted relative to its soleplate, thereby causing an unwanted movement in rotation of the viewed article, or in the orientation of the viewpoint of the scene being displayed. That unwanted movement occurs both in isotonic operation and in elastic operation.

### OBJECT OF THE INVENTION

The object of the invention is to propose a solution for remedying those drawbacks.

### SUMMARY OF THE INVENTION

To this end, the invention provides a mouse having six movement axes, the mouse comprising a soleplate and a housing connected to each other by a connection element allowing the housing to tilt relative to the soleplate in pivoting about two axes, and resilient return means tending continuously to return the housing to a neutral angle of tilt relative to the soleplate, wherein the housing is provided with a sensor or pushbutton situated in register with the thumb of the right hand of a user holding the housing in order to activate or deactivate a three-dimensional mode of use of the mouse on detecting a pressure force exerted on the sensor being applied or released, e.g. by the user's thumb.

Because of the reaction forces exerted spontaneously by the ring finger and the little finger of the user when the user applies pressure to the sensor with the thumb, said pressure does not cause the housing to move, thus making it possible to activate and deactivate three-dimensional mode without any risk of unwanted movement of the housing.

The invention also provides a mouse as defined above, wherein the sensor presents a bearing surface such that the normal to said bearing surface is oriented along an axis that intersects the connection element whereby the soleplate is connected to the housing.

The invention also provides a mouse as defined above, wherein the sensor is a pushbutton.

The invention also provides a mouse as defined above, wherein the sensor presents an outside surface projecting beyond the housing so as to be identifiable by feel by the user's thumb.

The invention also provides a mouse as defined above, wherein the bearing surface of the sensor presents an area that is sufficiently small to enable the thumb to bear against the housing beside the sensor.

The invention also provides a mouse as defined above, wherein the sensor is a click wheel.

The invention also provides a method of using a mouse having six movement axes, the mouse comprising a soleplate and a housing connected to each other by a connection element allowing the housing to tilt relative to the soleplate by pivoting about two axes, and resilient return means tending continuously to return the housing to a neutral angle of inclination relative to the soleplate, wherein a three-dimensional mode of utilization of the mouse is activated or deactivated on detecting the application or the release of a pressure force exerted by a finger of the hand of a user on at least one sensor or pushbutton fitted to the housing of the mouse.

### BRIEF DESCRIPTION OF THE FIGURES

FIG. 1 is a side view of the mouse of the invention.

FIG. 2 is a front view of the mouse of the invention.

FIG. 3 is a view from beneath the mouse of the invention.

FIG. 4 is a plan view of the mouse of the invention.

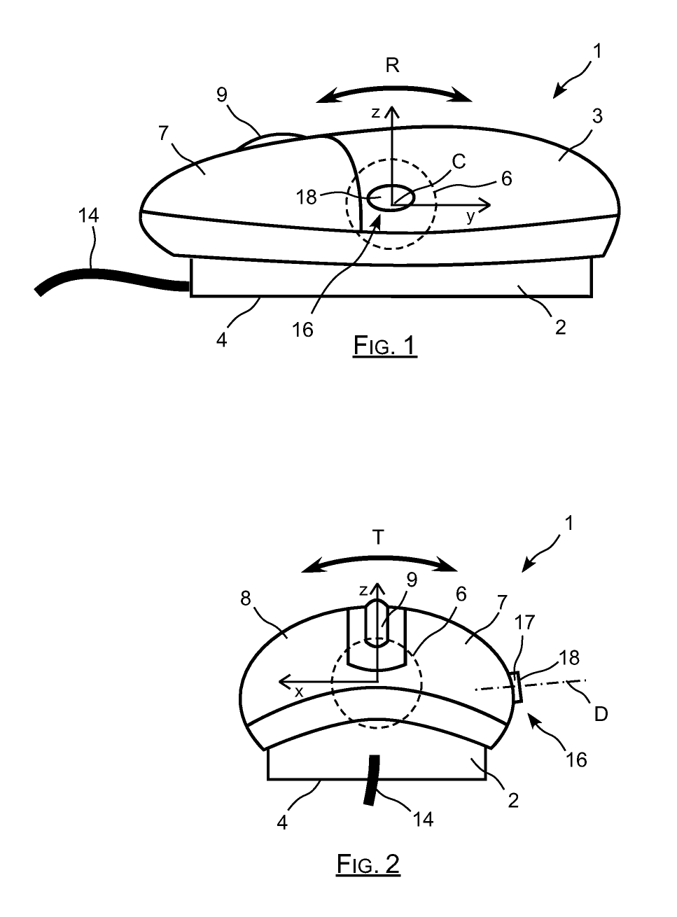

### DETAILED DESCRIPTION OF THE INVENTION

The idea on which the invention is based is to enable the user to activate the three-dimensional mode of the mouse by acting on one or more pushbuttons or sensors fitted to the mouse housing and in such a manner as to give rise to very little or no unwanted movement of the housing.

The mouse of the invention is given reference 1 in the figures and comprises a soleplate 2 carrying a housing 3 that is generally of a rounded ergonomic shape, making it easy for a user to hold in the hand.

The soleplate 2 has a plane bottom face 4 whereby it bears against a horizontal plane such as a table, the mouse 1 as a whole thus being suitable for being moved in translation along two mutually perpendicular horizontal axes referenced x and y, and in rotation about an axis that is normal to said plane, this axis being referenced z.

The housing 3 of the mouse 1 is connected to the soleplate 2 via a connection element 6 that enables the housing 3 to pivot relative to the soleplate 2 about two mutually perpendicular axes x and y that are parallel to the bottom face 4. In the example shown in the figures, the axes x, y, and z are the axes of a left-hand orthogonal frame of reference, with each axis passing through the center, referenced C, of the connection element 6.

It should be observed that the connection between the soleplate and the housing prevents the housing from moving vertically relative to the soleplate, and also prevents the housing from turning about the axis z relative to the soleplate.

By way of example, the element 6 comprises a spherical element rigidly secured to the soleplate 2 and engaged in a spherical cavity rigidly secured to the housing 3, these two members constituting a pivot connection having its center C situated substantially at half-height inside the housing 3.

In addition, lugs projecting radially from the spherical portion engage in grooves in the spherical cavity of the housing 3 to prevent the housing from turning about the axis z relative to the soleplate. The connection element 6 also includes resilient means continuously tending to return the housing 3 towards a neutral reference position in which it is not tilted relative to the soleplate.

Pivoting movement of the housing 3 relative to the soleplate 2 about the axis x that extends in a generally longitudinal direction of the mouse 1 thus corresponds to the housing 3 performing a pitching movement, referenced T. Pivoting movement of the housing about the axis y that is oriented transversely thus corresponds to a roll movement, referenced R. Finally, turning of the mouse 1 about the axis z corresponds to a so-called “yaw” movement.

The housing 3 has two buttons 7 and 8 situated in a top region of its front portion, suitable for being pressed respectively by the index finger and the middle finger of the user holding the mouse, and thus serving to perform a left click and a right click. In addition, a scroll wheel 9 projects from the top region of the front portion of the housing 3, being located between the buttons 7 and 8.

The user holding the mouse in the hand can thus move the scroll wheel with the index finger or the middle finger in order to produce movement along a vertical axis, i.e. along the axis z.

The mouse thus has six effective movement axes, since the housing 3 is movable together with the soleplate in translation along the axes x and y and in rotation about the axis z, and it is movable relative to the soleplate in rotation about the axes x and y, and movement in translation along the axis z can be defined by movements applied to the scroll wheel 9.

The actual movements of the housing 3 of the mouse 1 and of its scroll wheel 9 may be translated into corresponding movements of a digital part presented by an application, as follows:
movement in translation along the axes x and y and in rotation about the axis z may be translated in absolute form, i.e. isotonically, by the corresponding movements of the digital element presented by the application;
tilting of the housing about the axis x or y may be translated by a speed of rotation of the digital article having a value that corresponds to the tilt angle relative to the position of the housing at rest, with return of the housing to the neutral position then causing the digital article to stop; and
movement in translation along the axis z may also be translated as a translation speed of the digital article at a value that corresponds to the amount of rotation imparted by the user to the scroll wheel relative to a neutral position of said scroll wheel relative to the housing.

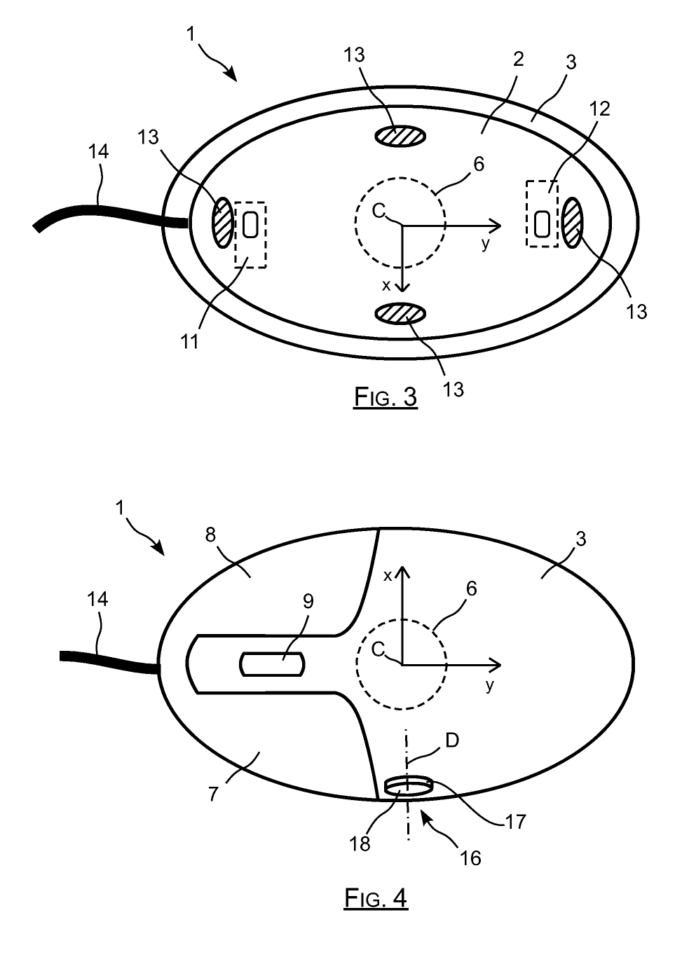

The actual movements of the mouse assembly 1 relative to the plane on which it rests are identified by information derived from two laser type movement sensors fitted to the soleplate 2 and located respectively at the front and at the rear thereof, these sensors being referenced respectively 11 and 12 in FIG. 3.

The information from these two laser sensors 11 and 12 thus makes it possible to determine the values for movements in translation along the axes x and y, and in rotation about the axis z (yaw movement), over a given time interval. These values correspond to the movements of the soleplate 2 relative to the table, the soleplate being provided with four skids referenced 13 in order to reduce sliding friction.

The mouse 1 is also provided with an inclinometer (not shown) having a base rigidly secured to the soleplate 2 and an arm that can tilt about the axes x and y, the arm being connected to move with the housing 3, so as to provide information representative of the angle of tilt of the housing relative to a neutral angular position. The inclinometer is advantageously incorporated in the connection element 6.

The connection element 6 is also fitted with resilient means tending to return the housing 3 towards a reference, or neutral, position relative to the soleplate, as soon as the user lets go of the mouse.

The sensors 11 and 12, the inclinometer, and also the scroll wheel 9 are connected to a printed circuit situated inside the mouse for processing the information they provide so as to transmit information relating to the position or the movement of the housing to the computer to which the mouse 1 is connected, in this example by a wire 14.

As can be seen in the figures, the mouse 1 of the invention is provided with a pushbutton 16 carried by the housing 3, being situated at the location where the user's thumb is spontaneously positioned when the user takes hold of the mouse.

Specifically, this button is situated on the left flank of the housing 3, being situated halfway along the mouse, i.e. halfway along the left flank, and it is situated vertically half way up the housing.

This pushbutton 16 includes a key 17 having a bearing face 18 defined by an elliptical outline that is designed to receive the user's thumb. The button 16 is movable between a released position corresponding to that shown in the figures, in which the bearing face 16 carried by the key 17 projects from the outside face of the housing 3, and a depressed position in which the bearing face 18 is substantially at the same level as the outside face of the housing 3.

As mentioned above, the button 16 is situated where the thumb of a user taking hold of the mouse in normal manner with the right hand would be located, and it moves between its released position and its depressed position in a travel direction, referenced D, that is normal to the bearing face 18 and that is oriented towards the center C of the connection element 6.

The button 16 is arranged to minimize the movements to which the housing 3 is subjected when the user presses or releases the button 16 with the thumb, whether these are movements of the mouse relative to the plane on which it rests, or movements in rotation of the housing 3 relative to the soleplate 2.

When the user presses the button 16 with the thumb while holding the housing 3, the housing 3 is subjected on its left side face to a force that is exerted by the thumb via the bearing face 18 of the button 16 and on its opposite right side face to another force, a reaction force that is oriented in the opposite direction and that is exerted by the user's ring and little fingers.

When the mouse is used by a left-handed user, the button 16 is in register with the ring and/or little finger of the left hand holding the mouse, thus enabling such a user to press in or release the button in analogous manner, the forces exerted for pressing or releasing the button 16 then being compensated by the force exerted by the thumb on the housing.

Under such conditions, the resultant of the forces exerted on the housing as a whole by the fingers of the user pressing on the pushbutton 16 is substantially zero, such that any risk of the housing moving is more or less zero. The same applies when the user releases the button.

In order to further reduce any risk of the housing moving under the effect of the pushbutton 16 being depressed or released, the button 16 is configured to move from its released position towards its depressed position, or vice versa, in a direction that is oriented towards the center C of the connection element 6.

Advantageously, the direction D along which the pushbutton 16 moves between its released and depressed positions coincides with the normal to the bearing surface 18 of the button so that the forces exerted by the thumb when depressing or releasing it are oriented towards the center C of the element 6 in such a manner as to obtain a moment relative to said center C that is zero.

As can be understood from the description above, unwanted movement of the housing is made even smaller when the distance between the center C of the connection and the travel axis D of the button 16 is small. When the button is unable to move because it is mounted to move in rotation about an axis that is offset from its bearing surface 18, the direction D coincides with the tangent to the movement trajectory of the button between its released position and its depressed position.

So as to be close to the center of the connection element C, the direction D generally intersects said connection element, intersecting both the portion of said connection element that is rigidly secured to the soleplate and the portion of said connection element that is rigidly secured to the housing, these two portions being engaged one in the other in order to define the center C of the connection.

Various configurations may be provided to switch from three-dimensional mode to two-dimensional mode, and vice versa. Switching from the current mode to the other mode may be caused when the user pushes in and then releases the button 16.

Advantageously, three-dimensional mode is activated when the user holds the pushbutton 16 in a depressed position, and two-dimensional mode is activated when the button 16 is released. Under such circumstances, the button is advantageously designed to project beyond the outside face of the housing when it is released, thereby enabling the user to be able to tell by feel whether or not the thumb is in position over the button 16.

On switching from one mode to the other, a signal is sent by the mouse to its driver so that it is presented to the operating system and to the active application, as appropriate, either as a three-dimensional mouse associated with an article or a scene, or else as a two-dimensional mouse controlling the movements of the cursor on the screen.

The position of the sensor under the thumb, and its orientation towards the center of the connection element, make it possible to obtain practically non-existent movement of the housing when the thumb exerts a force on this sensor or releases it. Thus, applying or releasing thumb pressure does not cause the housing to move, thereby enabling mode switching to be very fluid.

Furthermore, when switching to three-dimensional mode, the software driving the mouse may be designed to store in memory the current position of the housing 3 relative to the soleplate 2 at the instant when the sensor 16 detects thumb presence or pressure.

This current position of the housing is then associated with the current position of the digital article presented by the three-dimensional application, so as to constitute an origin point. This solution constitutes an additional assurance that the article in question will not move unexpectedly on switching to three-dimensional mode.

In the example shown in the figures, it is a pushbutton 16 that is situated in register with the user's thumb and that serves to go from one mode to the other by being depressed and/or released.

Solutions other than a pushbutton could also be envisaged, such as for example an inductive sensor situated at the same location as the button in order to identify the presence or the absence of the thumb. A shape in relief could advantageously be provided on the outside space of the housing, in register with the sensor, so that the user can determine by feel whether the thumb is or is not at the location in question.

Under such circumstances, the inductive sensor detecting the presence of the thumb represents the thumb exerting a pressure on the housing, as soon as a certain threshold is reached in the detection signal issued by the sensor.

Advantageously, the sensor is a click wheel situated in register with the thumb to detect the presence of the thumb when the wheel is pressed in towards the center C of the element connecting the housing to the soleplate. This click wheel is then arranged horizontally so that the user controls a yaw movement by moving the thumb from front to rear or vice versa while keeping the click wheel pressed in.

Alternatively, the switching from one mode to the other may be caused by the user simultaneously pressing on the left and right click buttons of the mouse, i.e. both buttons 7 and 8 using respectively the index and middle fingers. Applying or releasing a click, a pushbutton, or a sensor fitted to the housing of the mouse generates an unwanted movement of the housing through an amplitude that is small, and is thus well adapted to activating and deactivating the three-dimensional mode of the mouse.

The need to depress both click buttons of the mouse simultaneously also makes it possible to give the user a solution in which an intuitive gesture is performed pressing the index and middle fingers on the left and right click buttons of the mouse in a movement like taking hold of the mouse, when it is desired to activate three-dimensional mode.

It should be observed that in the example of the figures, the mouse presents a soleplate that is movable in translation relative to the plane on which the mouse is resting, and a housing that is capable of tilting relative to the soleplate. However the invention is also applicable to a three-dimensional mouse having a soleplate secured to a support or a baseplate that is stationary relative to the table, being movable in translation along two axes relative to said stationary baseplate and in rotation about a vertical axis.

Furthermore, in the example of the figures, the invention is applied to a three-dimensional mouse, however it applies equally well to other types of three-dimensional pointer presenting a movable portion taken hold of by the hand of a user in order to impart movements to a digital article, providing the movable portion has a sensor or a pushbutton for providing switching to a three-dimensional mode of use of the mouse without causing the article in question to move in untimely manner as a result of such switching.

1. A mouse (1) having six movement axes (x, y, z), the mouse comprising a soleplate (2) and a housing (3) connected to each other by a connection element (6) allowing the housing to tilt relative to the soleplate in pivoting about two axes (x, y), and resilient return means tending continuously to return the housing (3) to a neutral angle of tilt relative to the soleplate (2), together with means for detecting the angle of tilt of the housing (3) relative to the soleplate (2) and for detecting the movements of the soleplate (2) relative to a plane on which it rests, wherein the housing (3) is provided with a sensor or pushbutton (16) situated in register with a thumb of the right hand of a user holding the housing (3) in order to activate or deactivate a three-dimensional mode of use of the mouse on detecting a pressure force exerted on the sensor (16) being applied or released, e.g. by the user's thumb.

2. A mouse (1) according to claim 1, wherein the sensor (16) presents a bearing surface (18) such that the normal to said bearing surface (18) is oriented along an axis (D) that intersects the connection element (6) whereby the soleplate (2) is connected to the housing (3).

3. A mouse (1) according to claim 1, wherein the sensor (16) is a pushbutton.

4. A mouse (1) according to claim 1, wherein the sensor (16) presents an outside surface (18) projecting beyond the housing so as to be identifiable by feel by the user's thumb.

5. A mouse (1) according to claim 1, wherein the bearing surface (18) of the sensor (16) presents an area that is sufficiently small to enable the thumb to bear against the housing (3) beside the sensor (16).

6. A mouse (1) having six axes according to claim 1, wherein the sensor is a click wheel.

7. A method of using a mouse (1) having six movement axes (x, y, z), the mouse comprising a soleplate (2) and a housing (3) connected to each other by a connection element (6) allowing the housing to tilt relative to the soleplate by pivoting about two axes (x, y), and resilient return means tending continuously to return the housing (3) to a neutral angle of inclination relative to the soleplate (2), wherein the method comprises:
activating or deactivating a three-dimensional mode of utilization of the mouse (1) on detecting the application or the release of a pressure force exerted by a finger of the hand of a user on at least one sensor or pushbutton fitted to the housing (3) of the mouse.
